(19) United States
(12) Patent Application Publication
(10) Pub. No.: US 2014/0372135 A1
(43) Pub. Date: Dec. 18, 2014

(54) METHOD AND SYSTEM FOR SIGNAL FINGERPRINTING GEOGRAPHIC LOCATION OF A PERSON OR OBJECT

(71) Applicants: Michael Mittelman, Philadelphia, PA (US); Dirk J. Rassloff, Laguna Niguel, CA (US)

(72) Inventors: Michael Mittelman, Philadelphia, PA (US); Dirk J. Rassloff, Laguna Niguel, CA (US)

(21) Appl. No.: 14/301,723

(22) Filed: Jun. 11, 2014

Related U.S. Application Data
(60) Provisional application No. 61/834,107, filed on Jun. 12, 2013.

(51) Int. Cl. G06F 19/00; H04W 4/00; H04L 29/08

(52) U.S. Cl. CPC G06F 19/3406; H04L 67/12; H04W 4/008
USPC 705/2

(57) ABSTRACT

A method for geographic fingerprinting for monitoring of home services Interactions between a provider of a home service and a patient. The method and system are directed to presence determination (who is at a specific location at a specific time) rather than GPS location services (pinpointing that location). This service will uses a multi-pass authentication system to verify the co-located presence of a patient and service provider along with verification of time and geographic location of the patient and provider against multiple pre-specified static and dynamic parameters.

### CROSS-REFERENCE TO RELATED APPLICATIONS

This utility application claims the benefit under 35 U.S.C. §119(e) of provisional application Ser. No. 61/834,107 filed on Jun. 12, 2013 and entitled Method and System for Signal Fingerprinting Geographic Location of a Person or Object. The entire disclosure of this provisional application is included herein by reference.

### STATEMENT REGARDING FEDERALLY SPONSORED RESEARCH OR DEVELOPMENT

“Not Applicable”

### INCORPORATION-BY-REFERENCE OF MATERIAL SUBMITTED ON A COMPACT DISK

“Not Applicable”

### FIELD OF THE INVENTION

The present disclosure is related to geographic fingerprinting for monitoring of home services Interactions between a provider of a home service and a patient. More specifically, the present disclosure is related to presence technology (who is at a specific location at a specific time) rather than GPS location services (pinpointing that location).

### BACKGROUND OF THE INVENTION

The market for delivery of home services in the United States is estimated to reach more than $136.1 billion by the year 2020. Challenges in the delivery of this type of services include tracking and monitoring of a geographically dispersed field-based workforce that cannot be directly supervised. Significant error and fraud in the recording of home services interactions has been reported. Patient health outcomes can also be put at risk if a home services provider fails to be present at a scheduled time. As a result, a patient could be left alone, or could fail to receive a service that has been scheduled or paid for.

### SUMMARY OF THE INVENTION

The present disclosure is related to geographic fingerprinting for monitoring of home services interactions between a provider of a home service and a patient. More specifically, the present disclosure is related to presence technology (who is at a specific location at a specific time) rather than GPS location services (pinpointing that location). Part of the presence tech value proposal is that it can provide greater presence fidelity since it does not rely on GPS alone. This service uses a multi-pass authentication system to verify the co-located presence of patient and provider along with verification of time and geographic location of patient and provider against multiple pre-specified parameters, some of which are static and others which are be dynamic.

### DESCRIPTION OF THE DRAWING

The following drawings disclose various embodiments of the present invention for purposes of illustration only and are not intended to limit the scope of the invention. For purposes of clarity, not every component may be labeled in every figure.

FIG. 1 is a block diagram of an exemplary system for verification of co-located presence of a patient and provider.

### DETAILED DESCRIPTION OF THE PREFERRED EMBODIMENT

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

For the purposes of this document, an “electronic device” refers to a device that includes a processor and tangible, computer-readable memory. The memory may contain programming instructions that, when executed by the processor, cause the device to perform one or more operations according to the programming instructions. Examples of electronic devices include personal computers, gaming systems, televisions, and portable electronic devices such as smartphones, personal digital assistants, cameras, tablet computers, laptop computers, GPS navigation devices, media players and the like.

A method and system are disclosed for geographic fingerprinting the presence of home services providers at a specified time and place with the assigned patient. The system will achieve this via presence technology (who is at a specific location at a specific time) comparing location signal parameters rather than only GPS location services (pinpointing that location). Part of the presence technology value is that it can provide greater presence fidelity since it does not rely on GPS alone, but also integrates local signals comprising of Wi-Fi signals, Bluetooth®, cellphone tower triangulation, 2Net®, a special Wi-Fi/Bluetooth® beacon and other signal emitters unique to the location. The distinct advantages are that any combination of the signals can be captured as a geographical fingerprint; making the system not just reliant on GPS/cellphone tower triangulation and allowing a more accurate location capture.

The system may alert third parties of exceptions in real time and help to improve delivery of care, reduce fraud and error. The system is a multi-pass authentication system and interaction recording system for the recording of out-patient interactions, especially in the delivery of home services.

A reading/transmitting electronic device (such as a smart phone) will be provided to a health care provider. The device will include a software application (referred to herein as an “app”) that includes security in the form of a personal identification number (PIN), biometrics, gestures, or other security measures designed to prevent unauthorized access to the app; equipped with near field communication (NFC) or other wireless detection capability (e.g, Bluetooth®, radio frequency identification RFID), and the like, global position system (GPS) capability or another location service capable of determining the location of the device; a time stamp/clock; and wireless transmission and reception capabilities to send data real time, on demand/when triggered and at regular set intervals. The device also includes a mechanical, electronic, and/or software security method that is capable of preventing/blocking and/or tracking some or all of the device's functions. The lock/tracking may be implemented through the secured app described above, through a separate application, or within the operating system of the device.

The system also may include a wirelessly detectable object that will present the static parameter (such as a card, tag, or sticker) that will be provided to a patient. For simplicity, such an objected may be referred to as a “tag.”

A data storage facility such as a database is capable of holding the following information: identification (ID) of a health care provider in possession of the electronic device; ID of a patient holding tag; intended scheduled time and duration of health care intervention to be delivered; intended/scheduled location of health care intervention to be delivered and the parameters used to ID the geographical fingerprint. The system can also include additional receiving devices that gather information from the database, i.e. third party users/subscribers and devices such as computers or additional input devices (smartphone, tablet) that enter data into database via a software application.

### Work Flow of System

Using an internet-based/web-based portal accessed on a computer, smartphone, tablet, or other device, a registered user enters into the database (or pulls from an established data stream) the following data points: ID of a health care provider; ID of a patient; and health care intervention data such as scheduled/Intended time(s) and/or duration(s) of health care interventions to be delivered by provider to patient, and scheduled/Intended location of healthcare intervention to be delivered.

Each health care provider holds a reading/transmitting device with an application as described above. Each patient holds a readable NFC-enabled or Bluetooth® beacon object as described above (static parameter). When the provider's device and the patient's tag (static parameter) come into contact, the provider's device captures and/or sends the following data points to the database as described above:

A—ID of the health care provider or of the electronic device;

B—ID of the patient or of the tag;

C—Current time as indicated by electronic device; and

D—Current location as indicated by electronic device through the geographical fingerprint.

If some or all A, B, C, and D do not match the data held in the database within parameters circumscribed by an established decision engine, the lock as described above is not able to be unlocked and an exception report is generated. As a consequence of the exception report, an electronic message or other transmission (email, telephone call, SMS text message) is generated and sent to subscribing parties holding devices as described above (parties could include health care providers, case workers, hospital staff, management of health care providers, patient, or designated representatives of patient) to alert them to the exception and to prompt them to take an action to remedy the exception. Note that any combination of A, B, C, or D may be defined to trigger the lock, depending on user requirements.

In an embodiment, when the prior determined signals for the location fingerprinting ID do not match an alert will be generated.

If some or all of A, B, C, and D do match the data held in the database within parameters circumscribed by an established decision engine, the lock as described above is unlocked and an additional software application on electronic device, or additional features of the security application, can be initiated. Through the application, the health care provider can then record administrative and/or clinical data elements relevant to the health care intervention.

If the intervention has designated time duration entered into the database, the transmitting electronic device will at a regular interval transmit data elements C and D to database to check against the previously entered time and duration. If at any time elements C and D do not match the time and duration elements previously entered into database, the system triggers the lock to generate an exception report, triggering messages to external devices and a locking of the ability to use the electronic device to continue to record or transmit data regarding that home care interaction. Note that any combination of A, B, C, or D may be defined to unlock the device/app, depending on user requirements. Additionally, the system can via prior acknowledged time intervals ask the home service provider to repeat the interaction with the device and re-enter an ID or other interaction ensuring the presence of the provider in close proximity of the device and location. This proximity confirmation can be directed from the portal at the subscriber's discretion. These two systems will create a geographical virtual fence.

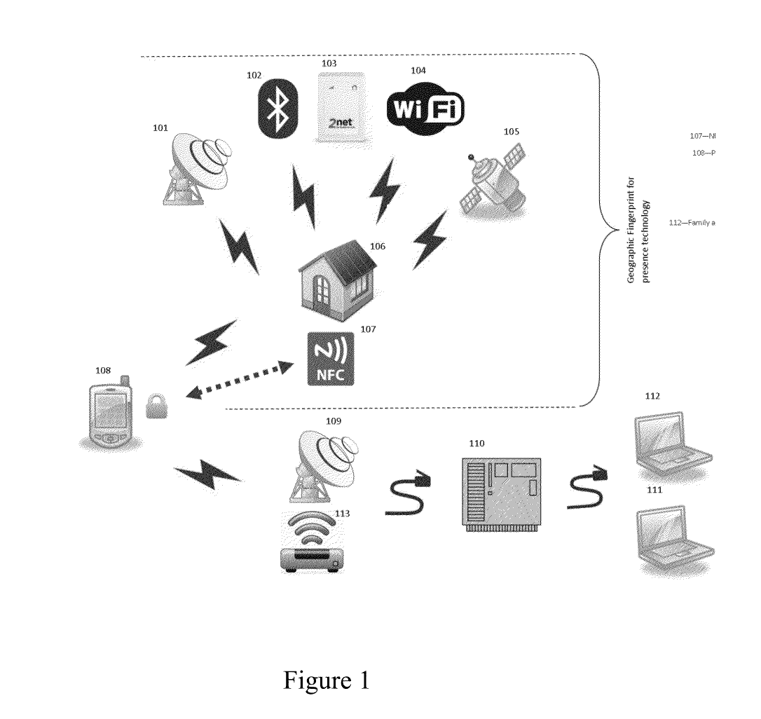

With reference to FIG. 1, The home service provider arrives at the patient's home 106 starts the App and touches the near field communication (NFC) enabled device 108 to the patient held NFC tag 107. The App at the time of the contact with the NFC tag or comes within range of a Bluetooth® beacon 108 determines the location through the fingerprinting technology comparing a predetermined set of signal emitters 101-105 to confirm the location of the home service provider. The app lock is engaged at the same time, allowing the capture of on the device 108 activity; in addition to the home services provider activity. This captured data is then transmitted to a server 110 via the cellphone data network 109 or other data networks, 113 either in real-time and/or in intervals when data networks are available.

Further shown in FIG. 1 are cell phone tower 101, Bluetooth transceiver 102, 2Net transceiver 103, WiFi transceiver, 104, GPS Satellite network 105

The captured information is confirmed on system host servers 110 and notifications, data and updates are shared with home service agencies 111 and/or family and other authorized third parties 112.

Without further elaboration the foregoing will so fully illustrate our invention that others may, by applying current or future knowledge, adopt the same for use under various conditions of service.

We claim:

1. A system for verifying that a patient and a provider are in the same location at a prescribed time, the system comprising:
a readable NFC-enabled object or Bluetooth® beacon in possession of the patient;
a computing device in possession of the provider, said computing having multiple wireless transceivers which can be used to geographically locate the computing device to form a geographic fingerprint and having a reader for reading said NFC-enabled object or Bluetooth® beacon;
at least one wireless communication network that the computing device can access; and
a remote data server in communication with said wireless communication network, wherein
when the provider's device and the patient's NFC-enabled object tag or Bluetooth® beacon come into contact, the provider's device captures and/or sends the following data points to the remote data sever:
A—ID of the health care provider or of the electronic device;
B—ID of the patient or of the tag;
C—Current time as indicated by electronic device; and
D—Current location as indicated by said geographical fingerprint.
